(19) United States
(12) Patent Application Publication
(10) Pub. No.: US 2026/0024216 A1
(43) Pub. Date: Jan. 22, 2026

(54) EFFICIENT CORRELATION VOLUME SAMPLING FOR OPTICAL FLOW ESTIMATION

(71) Applicants: DISNEY ENTERPRISES, INC., Burbank, CA (US); ETH Zürich (Eidgenössische Technische Hochschule Zürich), Zürich (CH)

(72) Inventors: Karlis Martins BRIEDIS, Zürich (CH); Christopher Richard SCHROERS, Uster (CH)

(21) Appl. No.: 19/273,031

(22) Filed: Jul. 17, 2025

Related U.S. Application Data
(60) Provisional application No. 63/673,133, filed on Jul. 18, 2024.

(51) Int. Cl. G06T 7/223; G06T 3/40; G06T 7/246

(52) U.S. Cl. CPC G06T 7/223; G06T 3/40; G06T 7/248; G06T 2207/20021; G06T 2207/20084

(57) ABSTRACT

One embodiment of the present invention sets forth a technique for performing optical flow estimation. The technique includes generating (i) a first block-based ordering of a first set of features associated with a source image and (ii) a second block-based ordering of a second set of features associated with a target image. The technique also includes matching a plurality of mappings between source pixels in the source image and target regions in the target image to a subset of blocks included in a correlation volume associated with the first block-based ordering and the second block-based ordering. The technique further includes computing a plurality of correlation values included in the subset of blocks and determining a plurality of flow vectors between the source image and the target image based on the plurality of correlation values.

### CROSS-REFERENCE TO RELATED APPLICATIONS

This application claims the benefit of the U.S. Provisional Application titled “COMPUTATIONALLY EFFICIENT ALL-PAIRS CORRELATION VOLUME SAMPLING,” filed on Jul. 18, 2024, and having Ser. No. 63/673,133. The subject matter of this application is hereby incorporated herein by reference in its entirety.

### BACKGROUND

### Field of the Various Embodiments

Embodiments of the present disclosure relate generally to computer vision and machine learning and, more specifically, to efficient correlation volume sampling for optical flow estimation.

### Description of the Related Art

Optical flow estimation is a computer vision technique that involves computing pixel-wise motion between video frames of a video. For example, optical flow estimation may be used to compute a dense vector field that includes a vector from each pixel in a first video frame to a corresponding pixel in a second video frame. The optical flow estimated between video frames can then be used to perform tasks such as (but not limited to) compressing the video, interpolating between video frames in the video, tracking objects across video frames, recognizing actions in the video, and/or performing video inpainting.

Recent optical flow estimation techniques typically involve computing a four-dimensional (4D) “correlation volume” that stores correlation values corresponding to measures of similarity between features of each pixel in the first video frame and each pixel in the second video frame. Values stored in this cost volume can then be sampled and used to iteratively refine flow vectors that represent estimated optical flow between the first and second video frames.

However, existing optical flow estimation techniques that involve sampling from correlation volumes involve a tradeoff between computational complexity and memory usage. More specifically, the complexity associated with computing a full “all pairs” correlation volume between all pixels in a first video frame and all pixels in a second video frame increases quadratically with respect to the number of pixels. Alternatively, a memory-efficient “on-demand” sampling approach may omit computation and storage of an all-pairs correlation volume and selectively compute correlations between pixel pairs that are relevant to the refinement of a given set of flow vectors. However, on-demand sampling involves frequent re-computation of the same correlation values and irregular memory access patterns that interfere with efficient implementation on existing hardware, thereby resulting in worse runtime performance than the all-pairs correlation volume sampling approach.

Further, the memory and/or compute requirements associated with correlation volume sampling can become significant and/or prohibitive with high-resolution video. For example, a dense all-pairs correlation volume for a 3584×8192 resolution video may consume 719 GB of storage, which exceeds the available memory on accessible hardware. On the other hand, on-demand sampling of the same video may have a runtime performance that is multiple times worse than sampling from an all-pairs correlation volume, which can interfere with real-time and/or low-latency optical flow estimation in the absence of significant compute resources.

As the foregoing illustrates, what is needed in the art are more effective techniques for performing correlation volume sampling for optical flow estimation.

### SUMMARY

One embodiment of the present invention sets forth a technique for performing optical flow estimation. The technique includes generating (i) a first block-based ordering of a first set of features associated with a source image and (ii) a second block-based ordering of a second set of features associated with a target image. The technique also includes matching a plurality of mappings between source pixels in the source image and target regions in the target image to a subset of blocks included in a correlation volume associated with the first block-based ordering and the second block-based ordering. The technique further includes computing a plurality of correlation values included in the subset of blocks and determining a plurality of flow vectors between the source image and the target image based on the plurality of correlation values.

One technical advantage of the disclosed techniques relative to the prior art is a reduction in the number of correlation values computed and stored in the correlation volume. Consequently, the disclosed techniques may reduce memory consumption over conventional optical flow estimation approaches that involve precomputing an entire “all pairs” correlation volume prior to selectively sampling from the correlation volume. Another technical advantage of the disclosed techniques is that, because computed correlation values are cached and reused across flow update iterations, the disclosed techniques reduce runtime and computational overhead compared with “on-demand” sampling approaches that compute correlations between pixel pairs that are relevant to individual flow update iterations. An additional technical advantage of the disclosed techniques is the ability to perform optical flow estimation for high-resolution video in a timely and/or feasible manner. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the processing engine and update engine of FIG. 1, according to various embodiments.

FIG. 3 illustrates how correlation features associated with a frame of video are computed, according to various embodiments.

FIG. 4 is a flow diagram of method steps for performing optical flow estimation using efficient correlation volume sampling, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

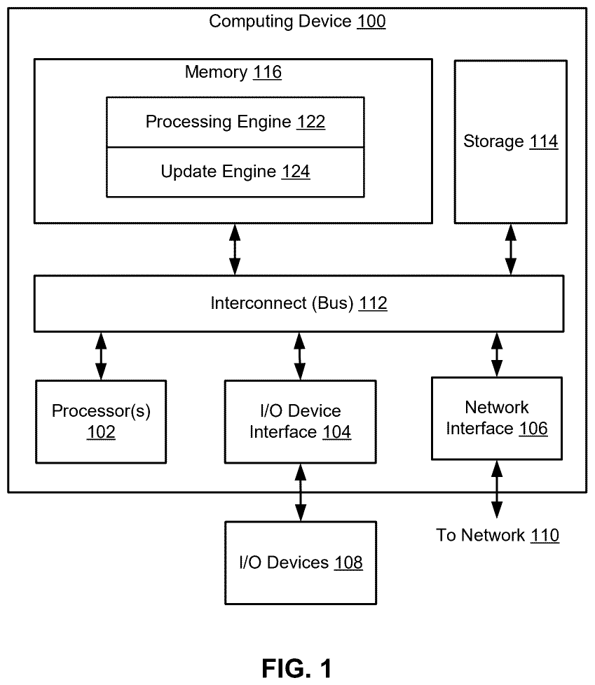

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a processing engine 122 and an update engine 124 that reside in a memory 116.

It is noted that the computing device described herein is illustrative and that any other technically feasible configurations fall within the scope of the present disclosure. For example, multiple instances of processing engine 122 and update engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Processing engine 122 and update engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including processing engine 122 and update engine 124.

In some embodiments, processing engine 122 and update engine 124 are configured to perform efficient correlation volume sampling for optical flow estimation. Processing engine 122 uses block-based orderings of pixels in a source image and a target image (e.g., two consecutive frames of video) to generate a sparse correlation volume between the source and target images. During generation of the sparse correlation volume, processing engine 122 computes a mask indicating pairs of blocks that span the source and target images and are associated with flow vectors between a first set of pixels in the source image and a second set of pixels in the target image. Processing engine 122 uses the mask to selectively populate the sparse correlation volume with a subset of correlation values between pixels spanning each pair of blocks.

Update engine 124 samples correlation features associated with the flow vectors from the sparse correlation volume and uses the sampled correlation features to iteratively refine the flow vectors. For example, update engine 124 may update the flow vectors over a number of flow update iterations. During a given flow update iteration, update engine 124 may input the correlation features, flow vectors outputted during a previous flow iteration (or initialized flow estimates during the first flow update iteration), and/or other types of data into a machine learning model. Update engine 124 may use the machine learning model to generate flow updates that are added to and/or otherwise combined with the flow vectors from the previous iteration to produce a new set of flow vectors for the current iteration. Update engine 124 may repeat the process over a certain number of iterations, until the flow estimates converge, and/or another condition is met. Processing engine 122 and update engine 124 are described in further detail below.

### Computationally Efficient All-Pairs Correlation Volume Sampling

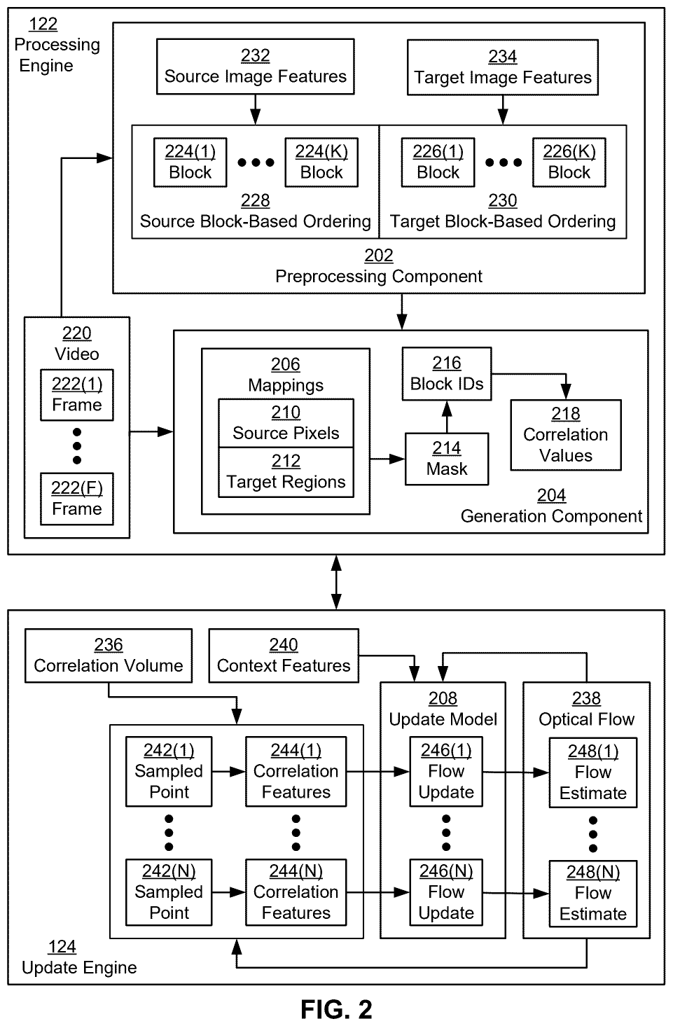

FIG. 2 is a more detailed illustration of processing engine 122 and update engine 124 of FIG. 1. As mentioned above, processing engine 122 and update engine 124 include functionality to perform efficient correlation volume sampling for optical flow estimation. Each of these components is described in further detail below.

In one or more embodiments, correlation volume sampling involves computing correlation values 218 that correspond to measures of similarity between source image features 232 of a source image and target image features 234 of a target image, storing the computed correlation values 218 in a four-dimensional (4D) correlation volume 236, and computing correlation features 244(1)-244(N) (each of which is referred to individually herein as correlation features 244) associated with pixels and/or other locations in the source image by selectively sampling correlation values 218 from correlation volume 236. The computed correlation features 244 may then be used to estimate and/or refine optical flow 238 between the source image and the target image.

In some embodiments, correlation volume sampling and/or optical flow estimation are performed for pairs of consecutive frames 222(1)-222(F) (each of which is referred to individually herein as frame 222) in a given video 220. During estimation of forward flow in a given pair of frames 222 that are ordered by time within video 220, the first frame 222 in the pair may correspond to the source image, and the second frame 222 in the pair may correspond to the target image. During estimation of backward flow in a given pair of frames 222 that are ordered by time within video 220, the second frame 222 in the pair may correspond to the source image, and the first frame 222 in the pair may correspond to the target image.

More specifically, given D-dimensional source image features 232 and target image features 234 F^{1,2}∈ [symbol] ^{H×W×D} extracted from a H×W source image and a H×W target image, respectively, a similarity, or correlation value, between a source pixel (or point) y in the source image and a target pixel (or point) x in the target image is computed as the dot product of the corresponding D-dimensional feature vectors:

$$C ( y , x ) = 〈 {F}_{y}^{1} , {F}_{x}^{2} 〉 . \qquad ( 1 )$$

The correlation value may also, or instead, include a Euclidean distance, cosine similarity, and/or another measure of similarity of distance between feature vectors for the source and target pixels.

In some embodiments, source image features 232 and target image features 234 are generated by an encoder neural network (or another type of machine learning model) from the corresponding frames 222 of video 220. Source image features 232 and target image features 234 may also, or instead, include pixel values and/or aggregations of pixel values from individual pixels and/or regions of pixels in the source image and target image, respectively.

Correlation features 244 for a given source pixel y from the source image can be computed by bilinearly sampling at a local grid around a corresponding target pixel of interest x in the target image, with subpixel sampled points 242(1)-242(N) (each of which is referred to individually herein as sampled point 242) within the local grid defined as integer offsets within a radius r:

$${𝒞}_{r} ( y , x ) = \{ 〈 {F}_{y}^{1} , {F}_{x + dx}^{2} 〉 \vert dx ∈ ℤ ⋀ {‖ dx ‖}_{∞} \leq r \} . \qquad ( 2 )$$

Additionally, correlation features 244 may be computed using mappings 206 from source pixels 210 in the source image to target regions 212 (or target pixels representative of the target regions) in the target image. These mappings 206 may be generated from flow estimates 248(1)-248(N) (each of which is referred to individually herein as flow estimate 248) that correspond to estimated, initialized, and/or “default” optical flow 238 between the source image and the target image.

The default implementation of correlation volume sampling first precomputes a dense “all pairs” (e.g., between each source pixel in the source image and each target pixel in the target image) 4D correlation volume 236 C∈ [symbol] ^{H×W×H×W}, where H and W are the height and width of both source image features 232 and target image features 234. This can be performed by flattening the source and target images along spatial dimensions and computing the full correlation volume 236 using a single matrix-matrix multiplication:

$$C = {\overline{F}}^{1} \cdot {\overline{F}}^{2} , \qquad ( 3 )$$

where F̅¹∈ [symbol] ^{[H}^{₁}^{×W}^{₁}^{]×D}, F̅²∈ [symbol] ^{[H}^{₂}^{×W}^{₂}^{]×D}. The output is reshaped back to four dimensions, and bilinear sampling is directly performed on the precomputed C to produce correlation features 244. Alternatively or additionally, a four-level pyramid may be constructed by average pooling the last two dimensions of C and performing a lookup on the pooled volumes to increase the perceptual window associated with the correlation volume sampling process.

Alternatively, a memory-efficient “on-demand” implementation may compute the values of Equation 2 directly for each source pixel in the source image. While this approach reduces memory complexity over computation of the dense 4D correlation volume, this approach can involve increased runtime and/or computational overhead due to operations that are not optimized for hardware and/or the lack of result reuse across iterations.

In one or more embodiments, processing engine 122 includes functionality to improve the memory and/or runtime overhead of correlation volume sampling by generating and updating a sparse correlation volume 236 that includes a subset of correlation values 218 from the dense 4D correlation volume. This subset of correlation values 218 may include correlation values 218 that are likely to be sampled based on mappings 206 of source pixels 210 in the source image to target regions 212 in the target image.

Processing engine 122 includes a preprocessing component 202 that generates a source block-based ordering 228 of source image features 232 associated with the source image and a target block-based ordering 230 of target image features 234 associated with the target image. To generate source block-based ordering 228 and target block-based ordering 230, preprocessing component 202 divides the source image into multiple contiguous blocks 224(1)-224(K) (each of which is referred to individually herein as block 224) and separately divides the target image into multiple contiguous blocks 226(1)-226(K) (each of which is referred to individually herein as block 226). For example, preprocessing component 202 may divide each of the source image and target image into a corresponding set of blocks 224 or 226 by padding the image to a multiple of a block size B (where B is manually set, determined using a heuristic, generated by a machine learning model, generated using an optimization technique, etc.) and dividing the padded image into B²-sized tiles.

Next, preprocessing component 202 organizes source image features 232 into source block-based ordering 228 based on blocks 224. Preprocessing component 202 additionally organizes target image features 234 into target block-based ordering 230 based on blocks 226. Continuing with the above example, preprocessing component 202 flattens per-pixel source image features 232 and target image features 234 within each block 224 or 226 in row-major order (e.g., from left to right starting from the top row of the block and proceeding downward). Preprocessing component 202 may additionally store the flattened features in blocks 224 or 226 in row-major order within source block-based ordering 228 and target block-based ordering 230, respectively. Preprocessing component 202 may also store each of source block-based ordering 228 and target block-based ordering 230 in a contiguous chunk of memory.

A generation component 204 in processing engine 122 determines block identifiers (IDs) 216 associated with pairs of blocks 224 and 226 from source block-based ordering 228 and target block-based ordering 230 for which correlation values 218 are to be computed. As shown in FIG. 2, generation component 204 uses mappings 206 from source pixels 210 in the source image to target regions 212 in the target image to generate a mask 214 that identifies block IDs 216. For example, generation component 204 may iterate over mappings 206 and determine, for each mapping, a first block 224 that includes a source pixel in the mapping and one or more additional blocks 226 that include a set of pixels within a target region in the mapping. Generation component 204 may also set one or more elements of mask 214 that represent pairs of the first block 224 and the additional block(s) 226 to a value indicating that correlation values 218 for the block pairs are to be computed.

Generation component 204 also uses mask 214 to populate correlation volume 236 with correlation values 218 between pixels in pairs of blocks 224 and 226 corresponding to the identified block IDs 216. Continuing with the above example, generation component 204 may compute a cumulative sum over mask 214 to determine the indexes of block pairs for which correlation values 218 are to be computed. Generation component 204 may then use sparse matrix-matrix-multiplication of two B⁴×D matrices corresponding to blocks 224 and 226 in the identified block pairs to compute the corresponding correlation values 218. Generation component 204 may additionally store the computed correlation values 218 in a sparse correlation volume 236.

Update engine 124 uses correlation values 218 in correlation volume 236 to iteratively update flow estimates 248 corresponding to optical flow 238 between the source image and the target image. For example, update engine 124 may initialize flow estimates 248 as zero-valued flow vectors (e.g., from each pixel or point location in the source image to the same pixel or point location in the target image). Update engine 124 may then generate a sequence of flow updates 246(1)-246(N) (each of which is referred to individually herein as flow update 246) that are used to revise flow estimates 248 over a number of flow update iterations.

In one or more embodiments, update engine 124 uses an update model 208 to generate flow updates 246 based on input that includes initialized and/or previously computed flow estimates 248, correlation features 244 sampled from correlation volume 236, and/or context features 240 associated with the source image. For example, update engine 124 may use an encoder neural network and/or another type of machine learning model to generate context features 240 from pixel values in the source image. Update engine 124 may use current flow estimates 248 to determine a set of sampled points 242 for a given flow update iteration. Sampled points 242 may include a grid of points around a target pixel in the target image that is mapped to a source pixel in the source image. Update engine 124 may compute correlation features 244 for these sampled points 242 using correlation volume 236 (e.g., by performing bilinear sampling of correlation values 218 in correlation volume 236). Update engine 124 may input representations of correlation features 244, context features 240, flow estimates 248, and/or a hidden state from a previous flow update iteration (if the previous flow update iteration has been performed) into a recurrent neural network, gated recurrent unit (GRU), convolutional neural network, and/or another type of machine learning model corresponding to update model 208. Update engine 124 may use update model 208 to convert the inputs into flow updates 246 that are applied to the current flow estimates 248 to generate an updated set of flow estimates 248 for the corresponding flow update iteration.

Thus, update engine 124 may generate a sequence of flow estimates 248 {f₁, . . . , f_{L}} from an initial set of flow estimates 248 (e.g., f₀=0) over L corresponding flow update iterations. During a current flow update iteration, update engine 124 may use update model 208 to generate flow updates 246 Δf that are added to flow estimates 248 from the previous flow update iteration to produce updated flow estimates 248 for the current flow update iteration (e.g., fᵢ₊₁=Δf+fᵢ). Update engine 124 may continue generating flow updates 246 and corresponding flow estimates 248 until a certain number of flow update iterations have been performed, flow estimates 248 converge (e.g., fᵢ→f*), and/or another condition is met.

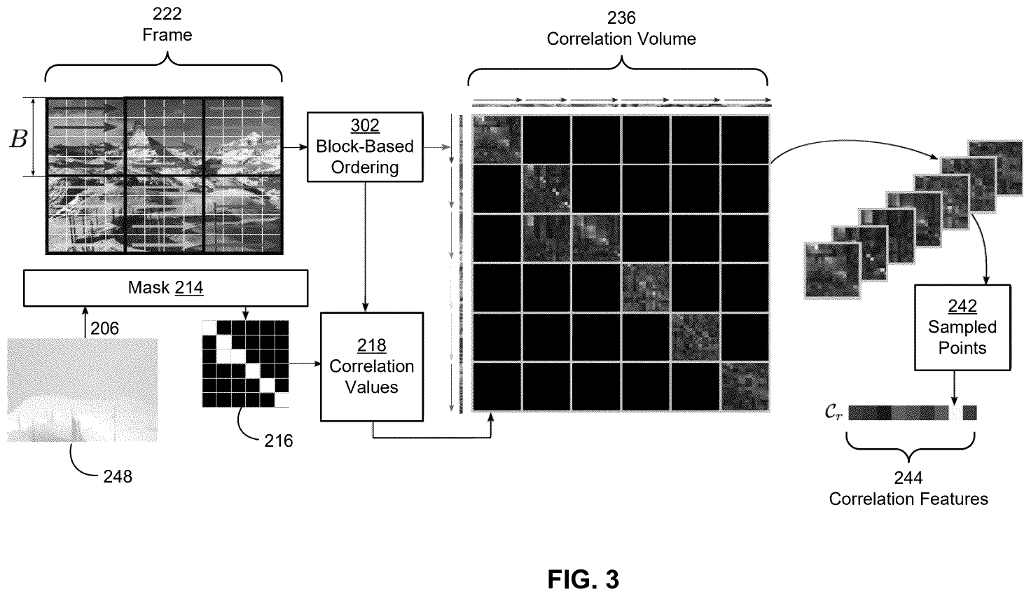

FIG. 3 illustrates how correlation features 244 associated with one or more frames 222 of video are computed, according to various embodiments. As shown in FIG. 3, each frame 222 may correspond to a source image or a target image. A block-based ordering 302 of features associated with frame 222 may be generated by dividing pixels and/or points in that frame 222 into contiguous blocks, flattening pixels and/or points within a given block in row-major order, and storing blocks of flattened pixels in row-major order.

Mappings 206 between source pixels 210 in the source image and target regions 212 in the target image are determined based on the most recent flow estimates 248 between the source image and the target image. These mappings 206 are also used to set elements in mask 214 that correspond to pairs of block IDs 216 in the source image and the target image. Each element that is set may indicate that correlation values 218 are to be computed for the corresponding pair of blocks in the source and target images.

Correlation values 218 for the identified pairs of blocks are computed as dot products and/or other measures of similarity between features in block-based ordering 302 of the source image and features in block-based ordering 302 of the target image. The computed correlation values 218 are stored in corresponding blocks (e.g., regions) within a sparse correlation volume 236, where each block in the sparse correlation volume 236 corresponds to a pair of blocks that includes a first block in the source image and a second block in the target image. Correlation values 218 associated with sampled points 242 in a given flow update iteration can then be retrieved from correlation volume 236 and used to compute corresponding correlation features 244 Cᵣ.

Returning to the discussion of FIG. 2, updated flow estimates 248 generated by update engine 124 during a given flow update iteration are used to update mappings 206. For example, each flow estimate 248 may include a flow vector from a source pixel in the source image to a target pixel in the target image. This flow estimate 248 may be used to generate a new set of mappings 206 from the source pixel to a target region around the target pixel (e.g., a lookup grid around the target pixel).

Generation component 204 uses the updated mappings 206 to update mask 214. Generation component 204 also computes additional correlation values 218 for pairs of block IDs 216 in mask 214 that are associated with the new mappings 206. These additional correlation values 218 are added to correlation volume 236 for use by update engine 124 in performing the next set of flow updates 246.

In one or more embodiments, generation component 204 updates correlation volume 236 with correlation values 218 associated with a given set of mappings 206 in a way that allows for reuse of previously computed correlation values 218 (e.g., for previous flow update iterations). For example, generation component 204 may compute the difference between mask 214 associated with a current set of mappings 206 and one or more masks associated with one or more previous sets of mappings 206 (e.g., from one or more previous flow update iterations). This difference may include one or more pairs of block IDs 216 that are included in the current set of mappings 206 and excluded from the previous set(s) of mappings 206. Generation component 204 may compute correlation values 218 for these pairs of block IDs 216 and add the computed correlation values 218 to correlation volume 236. Update engine 124 may then generate correlation features 244 for the next flow update iteration by sampling the newly added correlation values 218 and/or existing correlation values 218 from correlation volume 236.

In some embodiments, the operation of processing engine 122 and update engine 124 in performing correlation volume sampling is represented using the following sequence of steps:

```
Require: Flattened input features F^{1,2} ∈ [symbol]   ^{[H×W]×D}, source pixels Y ∈ [symbol]   ^{H×W×2},
      lookup centroids X ∈ [symbol]   ^{N×H×W×2}, block size B, lookup radius r.
bH, bW ← ┌H/B┐, ┌W/B┐
M ← [0]_{[bH×bW]×[bH×bW]}
for i = 0,1, ... , L − 1 do
  On Device for all {[y,x] ∈ [Y,Xᵢ]} × {dx ∈ {−r, −r + 1, ... , r}²}
    M_{└y/B┘,└(x+dx)/B┘} ← 1
  End Device
  blockIds ← cumulativeSum(M)
  blockIds [M ! = 1] ← −1
  updateCache(blocks, blockIds, M)
  blocks ← sampledBlockSparseMMM(F¹, F², blockIds)
  On Device for all {[y,x] ∈ [Y,Xᵢ]}
    shared memory localBlock[(2r + 2)²]
    for all dx′ ∈ {−r, −r + 1, ... , r, r + 1}² do
        blockId ← blockIds[└y/B┘][└(x + dx′ − r)/B┘]
        tmp ← blocks[blockId][└y┘ − B└y/B┘][└x + dx′┘ − B└(x + dx′)/B┘]
        localBlock[dx′ + r] ← tmp
    end for
    for all dx ∈ {−r, −r + 1, ... , r}² do
        sample localBlock[x − B└(x + dx)/B┘ + r]
    end for
  End Device
end for
```

In the above sequence, F^{1,2} represent source block-based ordering 228 of source image features 232 for a H×W source image and target block-based ordering 230 of target image features 234 for a H×W target image, Y represents a set of source pixels 210 in the source image, X represents centroids of target regions 212 in the target image to which source pixels 210 are mapped, B is a block size associated with blocks 224 and 226 in source block-based ordering 228 and target block-based ordering 230, and r is a lookup radius associated with target regions 212. The sequence begins with a first step of computing the number of blocks bH along the height of each image and the number of blocks bW along the width of each image. The sequence of steps also includes a second step of initializing a [bH×bW]×[bH×bW] mask 214 with zero values.

The sequence of steps continues with a for loop that iterates over L flow update iterations. During a given flow update iteration, elements of mask 214 that represent pairs of block IDs 216 for blocks in which source pixels 210 and corresponding target regions 212 are found are set to 1. Next, a “blockIds” variable is used to store a cumulative sum over mask 214 and assign sequential indices to pairs of block IDs 216 for which correlation values 218 are to be computed. Additionally, pairs of block IDs 216 that are not set to 1 in mask 214 are set to −1 within “blockIds” to indicate that correlation values 218 should not be computed for the corresponding pixel pairs in the source and target images.

A cache of previously computed correlation values 218 in correlation volume 236 is checked and/or updated using a set of “blocks,” “blockIds,” and mask 214. For example, the cache may be used to update “blockIds” with new pairs of block IDs 216 for which correlation values 218 are to be computed. Sparse matrix-matrix multiplication is then performed between source image features 232 and target image features 234 to populate blocks in correlation volume 236 that are associated with the new pairs of block IDs 216 with corresponding correlation values 218.

Correlation features 244 are then sampled using correlation values 218 in correlation volume 236. More specifically, the sequence loops over all mappings 206 of source pixels 210 to centroids of target regions 212. During each iteration of the loop, a “localBlock” is allocated in shared memory to store sampled correlation values 218 in a sampling grid that includes a local neighborhood of radius r around a centroid of a target region that is mapped to a corresponding source pixel. A first inner loop (which can be parallelized across multiple threads and/or processors) copies correlation values 218 at displacements dx′ within the sampling grid from “blocks” to “localBlock” using the corresponding “blockIds.” A second inner loop (which can be parallelized across multiple threads and/or processors) samples correlation features 244 for displacements dx from the centroid using correlation values in “localBlock.” These sampled correlation features 244 can then be used to generate flow updates 246 and new flow estimates 248 for the current flow update iteration, as discussed above.

In one or more embodiments, flow estimates 248 are recursively initialized at a lower resolution than the resolution of frames 222 in video 220. For example, update engine 124 may downsample a source image and target image from video 220 by a certain factor (e.g., when an input dimension associated with the source and target images exceeds a threshold). Update engine 124 may also use update model 208 and/or another technique to recursively initialize flow estimates 248 at the same downsampled resolution and/or a resolution that is higher than the downsampled resolution and lower than the original resolution of the source and target images. Update engine 124 may then upsample the initialized flow estimates 248 to the original resolution of the source and target images and refine flow estimates 248 at the original resolution using correlation values 218 and correlation volume 236 over a sequence of flow update iterations. This “cascaded inference” at different resolutions may improve the estimation of large displacements between the source and target images without requiring retraining and/or modification of update model 208 and/or other machine learning models involved in estimating optical flow 238.

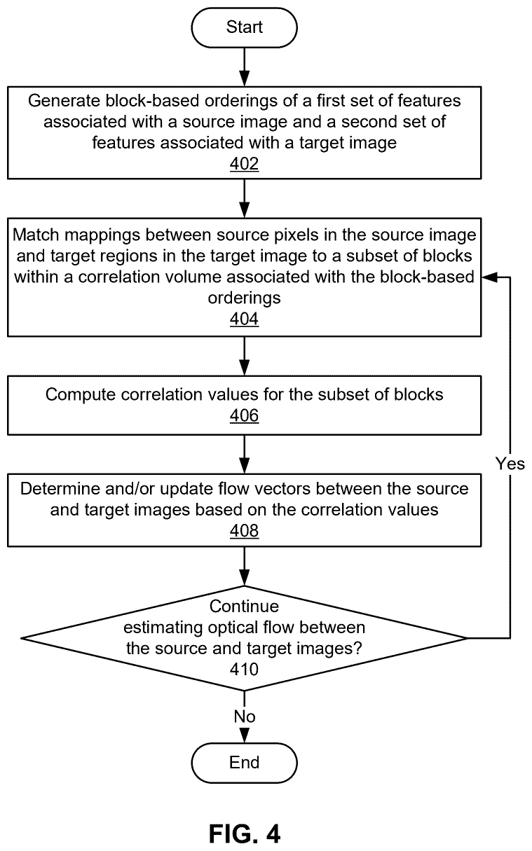

FIG. 4 is a flow diagram of method steps for performing optical flow estimation using efficient correlation volume sampling, according to various embodiments. Although the method steps are described in conjunction with the systems of FIGS. 1-2, persons skilled in the art will understand that any system configured to perform some or all of the method steps in any order falls within the scope of the present disclosure.

As shown, in step 402, processing engine 122 generates block-based orderings of a first set of features associated with a source image and a second set of features associated with a target image. For example, processing engine 122 may generate and/or obtain each set of features as pixel values from the corresponding image, aggregations of the pixel values, and/or learned features produced by a machine learning model from the pixel values. Processing engine 122 may divide each image into multiple contiguous blocks of a certain block size. Processing engine 122 may also flatten features within a given block in row-major order. Processing engine 122 may additionally store the flattened blocks of features for each image in row-major order within the corresponding block-based ordering.

In step 404, processing engine 122 matches mappings between source pixels in the source image and target regions of target pixels in the target image to a subset of blocks within a correlation volume associated with the block-based orderings. For example, processing engine 122 may determine the mappings based on initialized and/or previously computed flow vectors between the source and target images. For each mapping, processing engine 122 may match the source pixel and each target pixel in the target region to a pair of blocks that includes a first block in the source image and a second block in the target image. Processing engine 122 may update an element of a mask (or another type of data structure) with a value indicating that correlation values for the pair of blocks are to be computed. The element may correspond to a unique block within the correlation volume that can be used to store correlation values computed between pixels in the pair of blocks.

In step 406, processing engine 122 computes correlation values for the subset of blocks. Continuing with the above example, processing engine 122 may use the mask and/or a cache of previously computed blocks in the correlation volume to determine a set of new blocks for which the correlation values are to be computed. Processing engine 122 may also use sparse matrix-matrix multiplication of features in the block-based orderings to compute the correlation values for the new blocks.

In step 408, update engine 124 determines and/or updates flow vectors between the source and target images based on the correlation values. For example, update engine 124 may sample correlation features for each source pixel using bilinear interpolation of correlation values 218 associated with the source pixel. Update engine 124 may input the correlation features, existing flow vectors between the source and target images, context features associated with the source image, and/or other data associated with the images and/or flow vectors into a machine learning model. Update engine 124 may use the machine learning model to generate flow updates that are combined with the existing flow vectors to produce new flow vectors for a corresponding flow update iteration.

In step 410, processing engine 122 and/or update engine 124 determine whether or not to continue estimating optical flow between the source and target images. For example, processing engine 122 and/or update engine 124 may determine that optical flow should continue to be estimated until a certain number of flow update iterations have been performed, the flow vectors converge, and/or another condition is met.

While processing engine 122 and/or update engine 124 determine that optical flow should continue to be estimated, processing engine 122 and update engine 124 repeat steps 404, 406, and 408 over a number of corresponding flow update iterations. During each flow update iteration, processing engine 122 performs step 404 by using flow vectors from the previous flow update iteration to determine new mappings between source pixels in the source image and target regions in the target image. Processing engine 122 also uses the new mappings to identify blocks within the correlation volume for which correlation values are to be computed. Processing engine 122 performs step 406 to compute correlation values for some or all blocks identified in step 404. Update engine 124 then performs step 408 to generate new flow vectors between the source and target images based on the correlation values and the flow vectors from the previous flow update iteration. Processing engine 122 and/or update engine 124 may also perform step 410 to determine whether or not to continue refining the flow vectors. Once processing engine 122 and/or update engine 124 determine in step 410 that the flow vectors are no longer to be updated, flow vectors from the last flow update iteration may be used as representations of motion between the source and target images.

In sum, the disclosed techniques perform efficient correlation volume sampling for optical flow estimation. Block-based orderings of pixels in a source image and a target image (e.g., two consecutive frames of video) are used to generate a memory-efficient sparse correlation volume between the source image and the target image. A mask is used to store values that indicate pairs of blocks that span the source and target images and are associated with flow vectors between the source and target images. The sparse correlation volume is generated by computing a subset of correlation values associated with pairs of pixels spanning each pair of blocks identified in the mask. The computed correlation values are sampled and/or interpolated to generate correlation features associated with the flow vectors. The correlation features are then used by a machine learning model to iteratively update and/or refine the flow vectors.

One technical advantage of the disclosed techniques relative to the prior art is a reduction in the number of correlation values computed and stored in the correlation volume. Consequently, the disclosed techniques may reduce memory consumption over conventional optical flow estimation approaches that involve precomputing an entire “all pairs” correlation volume prior to selectively sampling from the correlation volume. Another technical advantage of the disclosed techniques is that, because computed correlation values are cached and reused across flow update iterations, the disclosed techniques reduce runtime and computational overhead compared with “on-demand” sampling approaches that compute correlations between pixel pairs that are relevant to individual flow update iterations. An additional technical advantage of the disclosed techniques is the ability to perform optical flow estimation for high-resolution video in a timely and/or feasible manner. These technical advantages provide one or more technological improvements over prior art approaches.

1. In some embodiments, a computer-implemented method for performing optical flow estimation comprises generating (i) a first block-based ordering of a first set of features associated with a source image and (ii) a second block-based ordering of a second set of features associated with a target image; matching a plurality of mappings between source pixels in the source image and target regions in the target image to a subset of blocks included in a correlation volume associated with the first block-based ordering and the second block-based ordering; computing a plurality of correlation values included in the subset of blocks; and determining a plurality of flow vectors between the source image and the target image based on the plurality of correlation values.

2. The computer-implemented method of clause 1, further comprising determining, based on the plurality of flow vectors, an additional plurality of mappings between the source pixels and additional target regions in the target image; matching the additional plurality of mappings to an additional subset of blocks in the correlation volume; and computing an additional plurality of correlation values included in the additional subset of blocks.

3. The computer-implemented method of any of clauses 1-2, wherein the plurality of correlation values is associated with a first iterative update to the plurality of flow vectors and the additional plurality of correlation values is associated with a second iterative update to the plurality of flow vectors.

4. The computer-implemented method of any of clauses 1-3, wherein the additional plurality of correlation values is computed for one or more blocks that are included in the additional subset of blocks and excluded from the subset of blocks.

5. The computer-implemented method of any of clauses 1-4, wherein generating the first block-based ordering and the second block-based ordering comprises dividing an image corresponding to the source image or the target image into a plurality of blocks; flattening each block included in the plurality of blocks in row-major order; and storing the flattened plurality of blocks in row-major order within a corresponding block-based ordering.

6. The computer-implemented method of any of clauses 1-5, wherein matching the plurality of mappings to the subset of blocks comprises for each mapping included in the plurality of mappings, determining (i) a block in the source image that includes a source pixel in the mapping and (ii) one or more blocks in the target image that include a target region in the mapping; and setting one or more values corresponding to the block and the one or more blocks within a mask associated with the correlation volume.

7. The computer-implemented method of any of clauses 1-6, wherein computing the plurality of correlation values comprises computing a plurality of dot products between a subset of the first set of features included in the block and an additional subset of the second set of features included in each of the one or more blocks.

8. The computer-implemented method of any of clauses 1-7, wherein determining the plurality of flow vectors comprises determining, based on the plurality of mappings, a target region in the target image that corresponds to a source pixel in the source image; computing a plurality of correlation features associated with the target region based on a subset of the plurality of correlation values associated with the target region; and updating a flow vector that is included in the plurality of flow vectors and associated with the source pixel in the source image based on the plurality of correlation features.

9. The computer-implemented method of any of clauses 1-8, wherein determining the plurality of flow vectors comprises initializing the plurality of flow vectors using a downsampled resolution associated with the source image and the target image; and updating the plurality of flow vectors using a resolution that is higher than the downsampled resolution based on the plurality of correlation values.

10. The computer-implemented method of any of clauses 1-9, wherein the first block-based ordering and the second block-based ordering are generated based on a block size associated with a plurality of blocks in the source image and the target image.

11. In some embodiments, one or more non-transitory computer-readable media store instructions that, when executed by one or more processors, cause the one or more processors to perform the steps of generating (i) a first block-based ordering of a first set of features associated with a source image and (ii) a second block-based ordering of a second set of features associated with a target image; matching a plurality of mappings between source pixels in the source image and target regions in the target image to a subset of blocks included in a correlation volume associated with the first block-based ordering and the second block-based ordering; computing a plurality of correlation values included in the subset of blocks; and determining a plurality of flow vectors between the source image and the target image based on the plurality of correlation values.

12. The one or more non-transitory computer-readable media of clause 11, wherein the instructions further cause the one or more processors to perform the steps of determining, based on the plurality of flow vectors, an additional plurality of mappings between the source pixels and additional target regions in the target image; computing an additional plurality of correlation values associated with the additional plurality of mappings; and updating the plurality of flow vectors based on the additional plurality of correlation values.

13. The one or more non-transitory computer-readable media of any of clauses 11-12, wherein computing the additional plurality of correlation values comprises determining a difference between the subset of blocks associated with the plurality of mappings and an additional subset of blocks that is included in the correlation volume and associated with the additional plurality of mappings; and computing the additional plurality of correlation values based on the difference.

14. The one or more non-transitory computer-readable media of any of clauses 11-13, wherein updating the plurality of flow vectors comprises generating, via execution of a machine learning model based on the additional plurality of correlation values, a plurality of flow updates associated with the plurality of flow vectors; and adding the plurality of flow updates to the plurality of flow vectors.

15. The one or more non-transitory computer-readable media of any of clauses 11-14, wherein generating the first block-based ordering and the second block-based ordering comprises dividing an image corresponding to the source image or the target image into a plurality of blocks; flattening each block included in the plurality of blocks in row-major order; and storing the flattened plurality of blocks in row-major order within a corresponding block-based ordering.

16. The one or more non-transitory computer-readable media of any of clauses 11-15, wherein matching the plurality of mappings to the subset of blocks comprises for each mapping included in the plurality of mappings, determining (i) a block in the source image that includes a source pixel in the mapping and (ii) one or more blocks in the target image that include a target region in the mapping; and setting one or more values corresponding to the block and the one or more blocks within a mask associated with the correlation volume.

17. The one or more non-transitory computer-readable media of any of clauses 11-16, wherein computing the plurality of correlation values comprises determining a plurality of similarities between a subset of the first set of features included in the block and an additional subset of the second set of features included in each of the one or more blocks.

18. The one or more non-transitory computer-readable media of any of clauses 11-17, wherein determining the plurality of flow vectors comprises determining, based on the plurality of mappings, a target region in the target image that corresponds to a source pixel in the source image; computing a plurality of correlation features associated with the target region based on an interpolation of a subset of the plurality of correlation values associated with the target region; inputting the plurality of correlation features and the plurality of flow vectors into a machine learning model; and generating, via execution of the machine learning model, a plurality of updates to the plurality of flow vectors.

19. The one or more non-transitory computer-readable media of any of clauses 11-18, wherein the instructions further cause the one or more processors to perform the step of generating, via execution of an encoder neural network, the first set of features and the second set of features.

20. In some embodiments, a system comprises one or more memories that store instructions, and one or more processors that are coupled to the one or more memories and, when executing the instructions, are configured to perform the steps of generating (i) a first block-based ordering of a first set of features associated with a source image and (ii) a second block-based ordering of a second set of features associated with a target image; matching a plurality of mappings between source pixels in the source image and target regions in the target image to a subset of blocks included in a correlation volume associated with the first block-based ordering and the second block-based ordering; computing a plurality of correlation values included in the subset of blocks; and determining a plurality of flow vectors between the source image and the target image based on the plurality of correlation values.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing optical flow estimation, the method comprising:
generating (i) a first block-based ordering of a first set of features associated with a source image and (ii) a second block-based ordering of a second set of features associated with a target image;
matching a plurality of mappings between source pixels in the source image and target regions in the target image to a subset of blocks included in a correlation volume associated with the first block-based ordering and the second block-based ordering;
computing a plurality of correlation values included in the subset of blocks; and
determining a plurality of flow vectors between the source image and the target image based on the plurality of correlation values.

2. The computer-implemented method of claim 1, further comprising:
determining, based on the plurality of flow vectors, an additional plurality of mappings between the source pixels and additional target regions in the target image;
matching the additional plurality of mappings to an additional subset of blocks in the correlation volume; and
computing an additional plurality of correlation values included in the additional subset of blocks.

3. The computer-implemented method of claim 2, wherein the plurality of correlation values is associated with a first iterative update to the plurality of flow vectors and the additional plurality of correlation values is associated with a second iterative update to the plurality of flow vectors.

4. The computer-implemented method of claim 2, wherein the additional plurality of correlation values is computed for one or more blocks that are included in the additional subset of blocks and excluded from the subset of blocks.

5. The computer-implemented method of claim 1, wherein generating the first block-based ordering and the second block-based ordering comprises:
dividing an image corresponding to the source image or the target image into a plurality of blocks;
flattening each block included in the plurality of blocks in row-major order; and
storing the flattened plurality of blocks in row-major order within a corresponding block-based ordering.

6. The computer-implemented method of claim 1, wherein matching the plurality of mappings to the subset of blocks comprises:
for each mapping included in the plurality of mappings, determining (i) a block in the source image that includes a source pixel in the mapping and (ii) one or more blocks in the target image that include a target region in the mapping; and
setting one or more values corresponding to the block and the one or more blocks within a mask associated with the correlation volume.

7. The computer-implemented method of claim 6, wherein computing the plurality of correlation values comprises computing a plurality of dot products between a subset of the first set of features included in the block and an additional subset of the second set of features included in each of the one or more blocks.

8. The computer-implemented method of claim 1, wherein determining the plurality of flow vectors comprises:
determining, based on the plurality of mappings, a target region in the target image that corresponds to a source pixel in the source image;
computing a plurality of correlation features associated with the target region based on a subset of the plurality of correlation values associated with the target region; and
updating a flow vector that is included in the plurality of flow vectors and associated with the source pixel in the source image based on the plurality of correlation features.

9. The computer-implemented method of claim 1, wherein determining the plurality of flow vectors comprises:
initializing the plurality of flow vectors using a downsampled resolution associated with the source image and the target image; and
updating the plurality of flow vectors using a resolution that is higher than the downsampled resolution based on the plurality of correlation values.

10. The computer-implemented method of claim 1, wherein the first block-based ordering and the second block-based ordering are generated based on a block size associated with a plurality of blocks in the source image and the target image.

11. One or more non-transitory computer-readable media storing instructions that, when executed by one or more processors, cause the one or more processors to perform the steps of:
generating (i) a first block-based ordering of a first set of features associated with a source image and (ii) a second block-based ordering of a second set of features associated with a target image;
matching a plurality of mappings between source pixels in the source image and target regions in the target image to a subset of blocks included in a correlation volume associated with the first block-based ordering and the second block-based ordering;
computing a plurality of correlation values included in the subset of blocks; and
determining a plurality of flow vectors between the source image and the target image based on the plurality of correlation values.

12. The one or more non-transitory computer-readable media of claim 11, wherein the instructions further cause the one or more processors to perform the steps of:
determining, based on the plurality of flow vectors, an additional plurality of mappings between the source pixels and additional target regions in the target image;
computing an additional plurality of correlation values associated with the additional plurality of mappings; and
updating the plurality of flow vectors based on the additional plurality of correlation values.

13. The one or more non-transitory computer-readable media of claim 12, wherein computing the additional plurality of correlation values comprises:
determining a difference between the subset of blocks associated with the plurality of mappings and an additional subset of blocks that is included in the correlation volume and associated with the additional plurality of mappings; and
computing the additional plurality of correlation values based on the difference.

14. The one or more non-transitory computer-readable media of claim 12, wherein updating the plurality of flow vectors comprises:
generating, via execution of a machine learning model based on the additional plurality of correlation values, a plurality of flow updates associated with the plurality of flow vectors; and
adding the plurality of flow updates to the plurality of flow vectors.

15. The one or more non-transitory computer-readable media of claim 11, wherein generating the first block-based ordering and the second block-based ordering comprises:
dividing an image corresponding to the source image or the target image into a plurality of blocks;
flattening each block included in the plurality of blocks in row-major order; and
storing the flattened plurality of blocks in row-major order within a corresponding block-based ordering.

16. The one or more non-transitory computer-readable media of claim 11, wherein matching the plurality of mappings to the subset of blocks comprises:
for each mapping included in the plurality of mappings, determining (i) a block in the source image that includes a source pixel in the mapping and (ii) one or more blocks in the target image that include a target region in the mapping; and
setting one or more values corresponding to the block and the one or more blocks within a mask associated with the correlation volume.

17. The one or more non-transitory computer-readable media of claim 16, wherein computing the plurality of correlation values comprises determining a plurality of similarities between a subset of the first set of features included in the block and an additional subset of the second set of features included in each of the one or more blocks.

18. The one or more non-transitory computer-readable media of claim 11, wherein determining the plurality of flow vectors comprises:
determining, based on the plurality of mappings, a target region in the target image that corresponds to a source pixel in the source image;
computing a plurality of correlation features associated with the target region based on an interpolation of a subset of the plurality of correlation values associated with the target region;
inputting the plurality of correlation features and the plurality of flow vectors into a machine learning model; and
generating, via execution of the machine learning model, a plurality of updates to the plurality of flow vectors.

19. The one or more non-transitory computer-readable media of claim 11, wherein the instructions further cause the one or more processors to perform the step of generating, via execution of an encoder neural network, the first set of features and the second set of features.

20. A system, comprising:
one or more memories that store instructions, and
one or more processors that are coupled to the one or more memories and, when executing the instructions, are configured to perform the steps of:
generating (i) a first block-based ordering of a first set of features associated with a source image and (ii) a second block-based ordering of a second set of features associated with a target image;
matching a plurality of mappings between source pixels in the source image and target regions in the target image to a subset of blocks included in a correlation volume associated with the first block-based ordering and the second block-based ordering;
computing a plurality of correlation values included in the subset of blocks; and
determining a plurality of flow vectors between the source image and the target image based on the plurality of correlation values.
